(19) United States
(12) Patent Application Publication
(10) Pub. No.: US 2007/0211471 A1
(43) Pub. Date: Sep. 13, 2007

(54) Dual Reflector System

(76) Inventor: Randal L. Wimberly, Paducah, KY (US)

Correspondence Address: KING & SCHICKLI, PLLC, 247 NORTH BROADWAY, LEXINGTON, KY, 40507, US

(21) Appl. No.: 10/577,580

(22) PCT Filed: Oct. 27, 2004
(86) PCT No.: PCT/US04/35653

§ 371 Date: Jan. 12, 2007

Related U.S. Application Data
(60) Provisional application No. 60/514,725, filed on Oct. 27, 2003.

(51) Int. Cl. F21V 7/00

(52) U.S. Cl. 362/297

(57) ABSTRACT

A dual reflector system includes a first reflector defining a first depth and a first focal point and a second reflector defining a second depth and a second focal point. The second depth is less than the first depth. The first and second reflectors are shaped and/or positioned such that the first reflector focal point is substantially the same as the second reflector focal point.

This application claims the benefit of U.S. Provisional Application Ser. No. 60/514,725, filed Oct. 27, 2003.

### TECHNICAL FIELD

The present invention relates to reflector systems for lamps, and more specifically, to a reflector system comprising dual reflectors for concentrating emitted light into a high-intensity light or energy beam in a controlled manner. Lighting fixtures and lamps in accordance with the teachings of the invention are provided also.

### BACKGROUND OF THE INVENTION

Ordinary lighting fixtures comprise a lamp, an external reflector for redirecting light emitted from the lamp in a desirable manner, and a housing surrounding the lamp and external reflector. Light generally emits in all directions from a light source such as a lamp filament. This is one reason that conventional lighting systems and electric lamps are inefficient in that significant portions of radiated light energy are lost. In a conventional incandescent lamp, for example, light energy radiating in the direction of the base of the lamp may be misdirected by the filament bridge and lost, or absorbed at the base of the lamp and converted into heat energy. Damage to the base of the lamp by such heat absorption is a significant cause of failure of conventional lamps. To address this inefficiency and redirect light in a desired direction, it is known to employ a reflective surface to reflect light from a direction in which it is not useful and projected towards a direction in which the light is useful. In this way, light reflectors increase the amount of light shining in a desired direction.

Typically, despite the use of reflectors, an excessive amount of light emitted by a light source is not projected in the desired direction. Instead, light becomes misdirected and absorbed by the non-reflective components in a light fixture such as the lamp base or the fixture housing. The misdirected light wastes electrical energy and leads to the undesired heating of the light fixture components. In many instances, the components of a light fixture may become warped by the excessive heat, and therefore must be replaced.

Particularly in the case of use in theater, television, and architectural lighting, a high intensity, controlled beam of light is required. It is known in the art to use external devices such as concave reflectors in conjunction with conventional lamps to capture and redirect emitted light into a usable, controlled beam. Similarly, the use of focusing lenses to shape a projected, redirected light beam into a desired pattern is known. However, such devices are not without problems. Conventional reflectors, particularly those used in high intensity lighting fixtures such as theater lights, still allow a significant escape of misdirected light, with the undesirable consequences described above. Focusing lenses-themselves contribute to misdirected and absorbed light. Further, conventional focusing lenses may create a “magnifying glass” effect similar to the phenomenon observed when energy emitted by the sun is collected and focused using a magnifying glass. In this phenomenon, emitted light and heat energy is compressed toward the center of the focused light beam, creating undesirable hot spots of light and heat energy in the focused beam. Finally, lenses make up a significant portion of the weight and cost of a light fixture, and are subject to breakage.

Still another problem with conventional solutions is that the projected light beam may have an intensity varying radially such that a concentric ring light pattern is projected. This undesired concentric ring pattern occurs because of variations in the shape of the bulb. In addition, the filament in the lamp appears as an image. Attempts to eliminate the filament shadow and concentric ring pattern by conventional means have resulted in an increased amount of misdirected light.

Thus, there is a need in the art for a light reflector which reduces misdirected and absorbed light. There is also a need to provide a light reflector which can shape reflected light into a desirable, highly concentrated beam, without requiring the use of supplemental devices such as lenses. Further, there is a need to provide a light reflector which can minimize the concentric ring pattern. Finally, there is a need to create a reflector system that does not compress energy in toward the center of the beam to cause hot spots of light and heat energy.

### SUMMARY OF THE INVENTION

In accordance with the need in the art identified above, in one aspect of the present invention a dual reflector system is provided for reflecting light produced by a lamp, comprising a first reflector defining a first depth and a first focal point and a second reflector defining a second depth and a second focal point. The second depth is less than the first depth. Further, the first and second reflectors are shaped and/or positioned such that the first reflector focal point is substantially the same as the second reflector focal point.

In one embodiment of the present invention, the first reflector includes at least one aperture whereby a lamp having a filament for producing light may be positioned in an interior of the first reflector, and the second reflector includes an aperture through which light energy produced by the lamp exits. It will be appreciated by the skilled artisan that any lamp design known in the art, including those which do not rely on a filament, can be used in the invention. In this embodiment, typically the first reflector aperture and the second reflector aperture are positioned in substantial alignment with a central longitudinal axis defined by the first reflector and the second reflector. In another embodiment, the first reflector includes at least one first aperture whereby a lamp having a filament for producing light may be positioned in an interior of the first reflector, and also includes a second aperture through which light energy produced by the lamp exits. In this latter embodiment, the second aperture is positioned in substantial alignment with a central longitudinal axis defined by the first reflector and the second reflector. The first reflector focal point and the second reflector focal point may be substantially on the central longitudinal axis defined by the first reflector and the second reflector.

In another aspect of this invention, a lighting fixture is provided for producing light from an electric current supplied from an external source and directing the light, comprising a lamp having an envelope, a filament disposed within the envelope for producing the light, at least two filament supports, and a base supporting the envelope and the filament supports, with the base having at least two contacts for supplying the electric current from the external source to the filament. Such lamp assemblies are known in the art. The lighting fixture of the present invention includes a reflector system, wherein the reflector system comprises a first reflector defining a first depth and a first focal point and a second reflector defining a second depth and a second focal point, and further wherein the second depth is less than the first depth. The first reflector focal point will typically be substantially the same as the second reflector focal point. The fixture may also include a housing for supporting the lamp and the reflector system.

The lamp assembly is typically positioned whereby the filament is held substantially at the first reflector focal point and the second reflector focal point. Again, it should be appreciated that any lamp design, including those which produce light without a filament, may be used. For example, a discharge lamp may be used. The important point is placing the light emitting source of the lamp substantially at the first reflector focal point and the second reflector focal point. In one embodiment of this invention, the first reflector includes at least one aperture through which the lamp is held in an interior of the first reflector, and the second reflector includes an aperture through which light energy produced by the lamp exits. The at least one first reflector aperture and the second reflector aperture are typically positioned in substantial alignment with a central longitudinal axis defined by the first reflector and the second reflector.

In an alternative embodiment, the first reflector includes at least one first aperture through which the lamp is held in an interior of the first reflector, and also includes a second aperture, through which light energy produced by the lamp exits. The second aperture is typically positioned in substantial alignment with a central longitudinal axis defined by the first reflector and the second reflector.

In yet another aspect of the present invention, a method is described for providing a high intensity beam of light, comprising providing a lamp having an envelope, a filament (or other light emitter) disposed within the envelope for producing the light, at least two filament supports, and a base supporting the envelope and the filament supports, wherein the base has at least two contacts for supplying the electric current from the external source to the filament. Such lamp assemblies are known in the art. Next is the step of providing a reflector system, comprising a first reflector defining a first depth and a first focal point and a second reflector defining a second depth and a second focal point. As noted above, typically the second depth is less than the first depth, and the first reflector focal point is substantially the same as the second reflector focal point. The lamp will be typically positioned such that the filament is held substantially at the first reflector focal point and the second reflector focal point. Next are the steps of providing an electric current to the filament from the external source, and radiating light from the filament.

In one embodiment of the method, the first reflector will include at least one aperture through which the lamp is held in an interior of the first reflector, and the second reflector will include an aperture through which light energy produced by the lamp exits. Typically, in this embodiment the at least one first reflector aperture and the second reflector aperture are positioned in substantial alignment with a central longitudinal axis defined by the first reflector and the second reflector. In another embodiment of the present invention, the first reflector includes at least one first aperture through which the lamp is held in an interior of the first reflector and a second aperture through which light energy produced by the lamp exits. The second aperture may be positioned in substantial alignment with a central longitudinal axis defined by the first reflector and the second reflector.

In still yet another aspect of the present invention, a lamp for producing light from an electric current supplied from an external source is provided. The lamp may comprise an envelope, a filament for producing the light, at least two filament supports, and a base supporting the envelope and the filament supports, the base having at least two contacts for supplying the electric current from the external source to the filament. The envelope comprises a first reflector defining a first depth and a first focal point and a second reflector defining a second depth and a second focal point, wherein the second depth is less than the first depth and further wherein the first reflector focal point is substantially the same as the second reflector focal point. The filament is disposed in an interior of the envelope, the first reflector, and the second reflector, and is typically positioned substantially at the first reflector focal point and the second reflector focal point.

In one embodiment of the lamp of the present invention, the first reflector includes an aperture through which light energy produced by the filament exits. The first reflector aperture may be positioned in substantial alignment with a central longitudinal axis defined by the first reflector and the second reflector. In an alternative embodiment, the second reflector is provided with an aperture through which light energy produced by the filament exits. The second reflector aperture may be positioned in substantial alignment with a central longitudinal axis defined by the first reflector and the second reflector. Typically, the lamp first reflector focal point and the second reflector focal point are substantially on a central longitudinal axis defined by the first reflector and the second reflector.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic longitudinal sectional view of lighting fixture comprising of a reflector system in accordance with the present invention;

FIG. 2 is a schematic longitudinal sectional view of a reflector system in accordance with an alternative embodiment of the present invention;

FIG. 3 is a schematic longitudinal sectional view of a lamp assembly produced in accordance with the present invention; and

FIG. 4 is a schematic longitudinal sectional view of a lamp assembly produced in accordance with an alternative embodiment of the present invention.

Reference will now be made in detail to the presently preferred embodiment of the invention, an example of which is illustrated in the accompanying drawings.

### DETAILED DESCRIPTION OF THE INVENTION

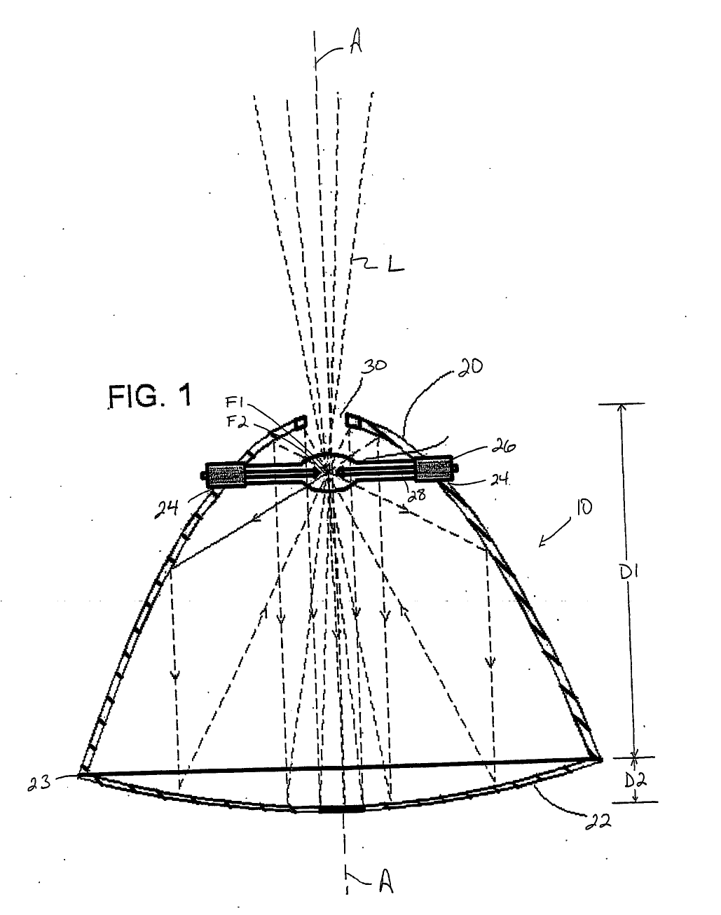

With reference to FIG. 1, there is shown an embodiment of a dual reflector system 10 for concentrating light produced by a lamp into a controlled, high intensity light or energy beam. The reflector system 10 includes first reflector 20 defining a first depth D1 and a first focal point F1 and a second reflector 22 defining a second depth D2 and a second focal point F2. The second depth D2 is less than the first depth D1. Further, the first and second reflectors 20, 22 are shaped and/or positioned such that the first reflector focal point F1 is substantially the same as the second reflector focal point F2. First and second reflectors 20, 22 may be joined at juncture 23, whereby escape of light rays L is substantially prevented. First and second reflectors 20, 22 may each define a parabolic curve, and do not define identical curvatures.

In the embodiment of the present invention depicted in FIG. 1, the first reflector 20 includes at least one first aperture 24 whereby a lamp 26 having a filament 28 for producing light (or other lamp design) may be positioned in an interior of the first reflector 20, and also includes a second aperture 30 through which light energy rays L produced by the lamp 26 exit. As shown in FIG. 1, in this embodiment the portion of first reflector 20 including aperture 30 is proximal to filament 28, and second reflector 22 is distal. Apertures 24 are adapted whereby lamp 26 may be inserted therethrough without any escape of light rays L. In this embodiment, the second aperture 30 is positioned in substantial alignment with a central longitudinal axis A defined by the first reflector 20 and the second reflector 22. The first reflector focal point F1 and the second reflector focal point F2 are located substantially on the central longitudinal axis A. As will be appreciated by referring to the schematic illustration in FIG. 1, in this embodiment the reflector system 10 of the present invention concentrates reflected light emitted by filament 28 into light rays L having a substantially smooth, radiating cone of light with no stray or misdirected beams, and with all light rays L evenly radiating from the focal points F1, F2.

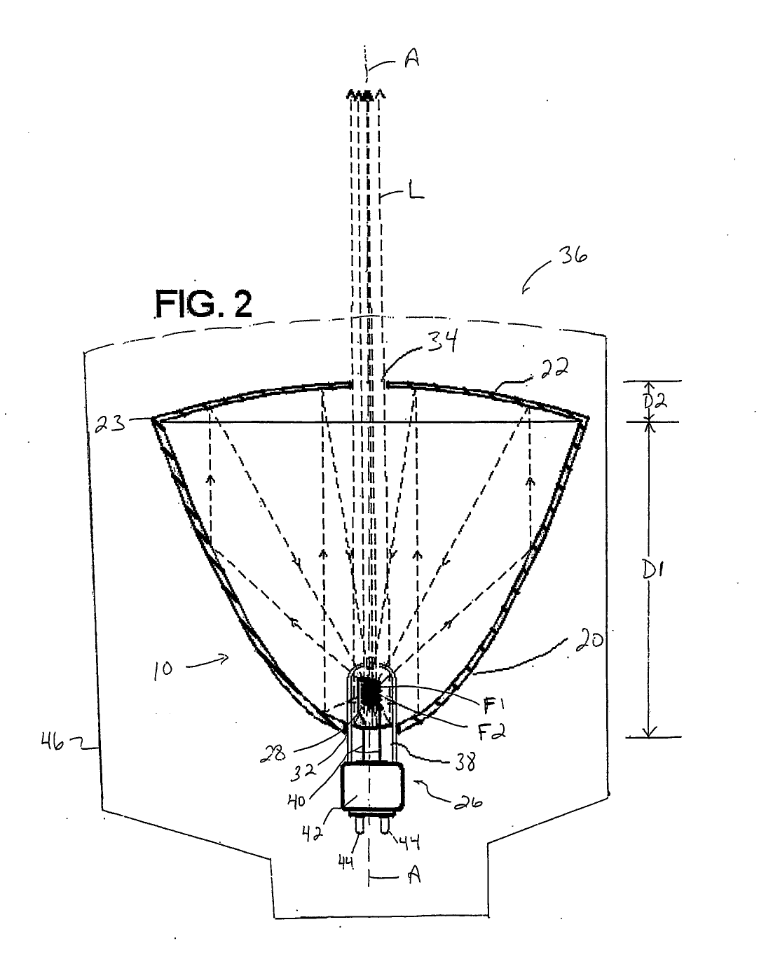

An alternative embodiment of the present invention is schematically illustrated in FIG. 2. The first reflector 20 includes at least one aperture 32 whereby a lamp 26 having a filament 28 for producing light may be positioned in an interior of the first reflector 20, and the second reflector 22 includes an aperture 34 through which light rays L produced by the lamp 26 exit. As shown in FIG. 2, in this embodiment the portion of second reflector 22 including aperture 34 is distal to filament 28, and the portion of first reflector 20 including aperture 32 is proximal. As described above, first and second reflectors 20, 22 may be joined at juncture 23 whereby escape of light rays L is substantially prevented.

In this embodiment, typically the first reflector aperture 32 and the second reflector aperture 34 are positioned in substantial alignment with a central longitudinal axis A defined by the first reflector 20 and the second reflector 22. As shown in FIG. 2, the depicted embodiment of the reflector system 10 gathers reflected light emitted by filament 28 into light rays L having a substantially parallel configuration, with tight, evenly packed parallel rays. Only light rays L leaving filament 28 and exiting the reflector system 10 without striking first reflector 20 or second reflector 22 may be marginally out of alignment. However, because the light source (filament 28) is held at a distance from the aperture 34, the majority of light rays L fall into the desired substantially parallel light path.

FIG. 2 also illustrates another aspect of this invention, being a lighting fixture 36 for producing light from an electric current supplied from an external source (not shown for convenience) and for concentrating reflected light into a controlled pattern. Fixture 36 comprises a lamp having an envelope 38, a filament 28 disposed within the envelope 38 for producing the light, at least two filament supports 40, and a base 42 supporting the envelope 38 and the filament supports 40, with the base 42 having at least two contacts 44 for supplying the electric current from the external source to the filament 28. Such lamp assemblies are known in the art. The lighting fixture 36 of the present invention includes a reflector system 10 as described above, comprising a first reflector 20 defining a first depth D1 and a first focal point F1 and a second reflector 22 defining a second depth D2 and a second focal point F2. D2 is less than D1. The first reflector focal point F1 will typically be substantially the same as the second reflector focal point F2. The fixture 36 may also include a housing 46 for supporting the lamp 26 and the reflector system 10. The lamp 26 assembly is typically positioned whereby the filament 28 is held substantially at the first reflector focal point and the second reflector focal point F1, F2. It will be appreciated by the skilled artisan that any embodiment of the present invention may be incorporated into the fixture 36, such as the embodiments shown in FIGS. 1 and 2 and described above. Any conventional lamp 26 assembly may be incorporated into fixture 36. Alternatively, specialized lamp assemblies, such as the lamp described in the inventor's U.S. Pat. No. 6,744,187 (incorporated herein by reference) may advantageously be used in combination with the present invention.

The present invention further provides a method for providing a high intensity, controlled beam of light, comprising providing a lamp 26 having an envelope 38, a filament 28 disposed within the envelope 38 for producing the light, at least two filament supports 40, and a base 42 supporting the envelope 38 and the filament supports 40. As is known in the art, the base 42 typically includes contacts 44 for supplying an electric current from the external source (not shown) to the filament 28. Such lamp assemblies are known in the art.

Next is the step of providing a reflector system 10, comprising a first reflector 20 defining a first depth D1 and a first focal point F1 and a second reflector 22 defining a second depth D2 and a second focal point F2. As noted above, D2 is less than the D1, and the first reflector focal point F1 is substantially the same as the second reflector focal point F2. The next step is positioning lamp 26 such that the filament 28 is held substantially at the first reflector focal point F1 and the second reflector focal point F2. Next, an electric current may be provided to the filament 28 from the external source, thereby causing the radiation of light from the filament 28 by methods well-known in the art.

As described above, in one embodiment (see FIG. 2) the first reflector 20 will include at least one aperture 32 through which the lamp 26 is held in an interior of the first reflector 20, and the second reflector 22 will include an aperture 34 through which light energy rays L produced by the lamp exit. Typically, in this embodiment the at least one first reflector aperture 24 and the second reflector aperture 34 are positioned in substantial alignment with a central longitudinal axis A defined by the first reflector 20 and the second reflector 22. In another embodiment (see FIG. 1), the first reflector 20 includes at least one first aperture 24 through which the lamp is held in an interior of the first reflector 20 and a second aperture 30 through which light energy rays L produced by the lamp exit. The second aperture 30 may be positioned in substantial alignment with the central longitudinal axis A.

It will be appreciated by the skilled artisan that the majority of light rays L emitting from the filament 28 enclosed by the reflector system 10 may take one of three paths. In the first path, light rays L emitted directly in alignment with the apertures 30 or 34 of the reflector system 10 exit directly. In the second path, emitted light rays L which strike the reflector distal from the filament 28 (second reflector 22) are reflected towards the reflector proximal to the filament 28 (first reflector 20). Redirected light rays L emitted directly through the apertures 30 or 34 of the reflector system 10 exit directly. In the third path, emitted light rays which strike the reflector proximal to the filament 28 (first reflector 20) are reflected towards the reflector distal to the filament 28 (second reflector 22), where they are again redirected to exit the reflector system 10 through the aperture 30 or 34, or again strike the reflector distal to the filament 28 and be reflected back towards the reflector proximal to the filament 28. This redirection of emitted light rays L is repeated. It will be appreciated that only light rays L directed towards focal points F1, F2 and substantially directionally aligned with apertures 30 or 34 exit the reflector system 10. This redirection of light rays L until substantial alignment with focal points F1, F2 and apertures 30 or 34 result in emission of a concentrated beam of light having the configurations described above.

The present invention therefore provides a reflector system 10 which may be adapted for use with any conventional lamp 26 to focus and concentrate light into a useful pattern. It is desirable also to provide a lamp in accordance with the present invention which produces a tightly regulated and concentrated beam of light in the absence of a separate reflector system 10 as described above. Accordingly, in still yet another aspect of the present invention, a lamp 46 for producing light from an electric current supplied from an external source (not shown for convenience) is provided. The lamp 46 comprises an envelope 48, a filament 50 for producing the light, at least two filament supports 52, and a base 54 supporting the envelope 48 and the filament supports 52, the base 54 having at least two contacts 56 for supplying the electric current from the external source to the filament 50. As noted above, other lamp designs may be used, including those that do not rely on a filament for producing light.

The envelope 48 comprises a first reflector 58 defining a first depth D1 and a first focal point F1 and a second reflector 60 defining a second depth D2 and a second focal point F2, wherein the second depth D2 is less than the first depth D1 and further wherein the first reflector focal point F1 is substantially the same as the second reflector focal point F2. The filament 50 is disposed in an interior of the envelope 48, the first reflector 58, and the second reflector 60, and is typically positioned substantially at the first reflector focal point F1 and the second reflector focal point F2. First and second reflectors 58, 60 may be joined at juncture 62 whereby the escape of light rays is substantially prevented.

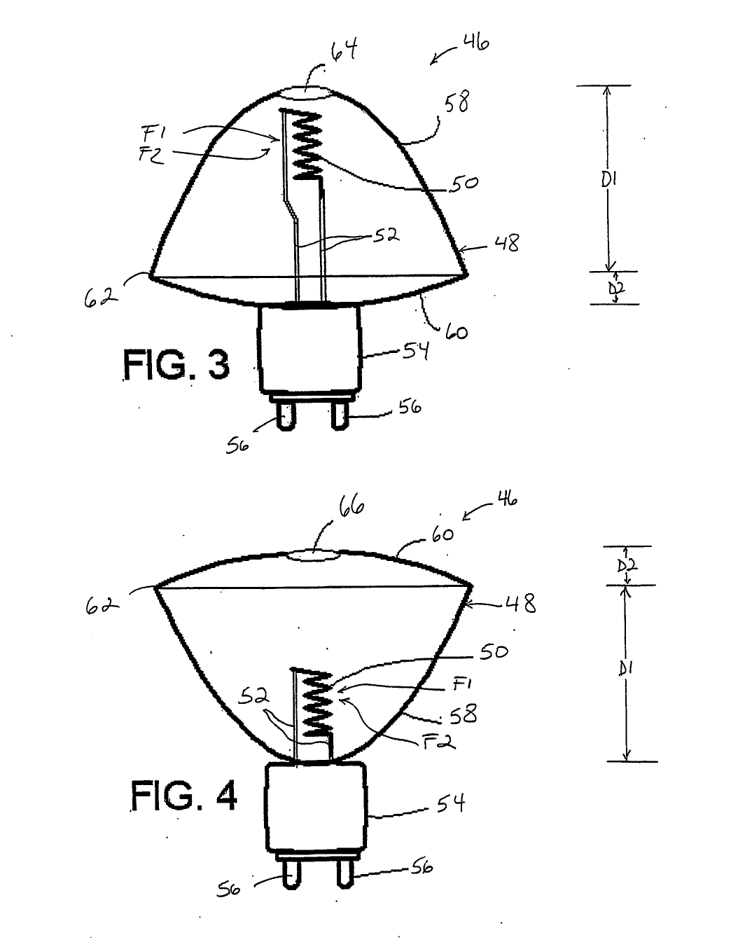

In one embodiment of the lamp 46 as schematically depicted in FIG. 3, the first reflector 58 includes an aperture 64 through which light energy produced by the filament 50 exits. The first reflector aperture 64 may be positioned in substantial alignment with a central longitudinal axis defined by the first reflector 58 and the second reflector 60. The skilled artisan will appreciate from the preceding discussion that in this embodiment, the first and second reflectors 58, 60 concentrate reflected light emitted by filament 50 into light rays having a substantially smooth, radiating cone of light with no stray or misdirected beams, and with all light rays evenly radiating from the focal points F1, F2.

In the alternative embodiment as depicted in FIG. 4, the second reflector 60 is provided with an aperture 66 through which light energy produced by the filament 50 exits. The second reflector aperture 66 may be positioned in substantial alignment with a central longitudinal axis defined by the first reflector 58 and the second reflector 60. Typically, the lamp first reflector focal point F1 and the second reflector focal point F2 are substantially on the central longitudinal axis defined by the first reflector 58 and the second reflector 60. It will be appreciated from the foregoing description that the depicted embodiment of the lamp 46 gathers reflected light emitted by filament 50 into light rays having a substantially parallel configuration, with tight, evenly packed parallel rays. Only light rays leaving filament 50 and exiting the lamp 46 without striking first reflector 58 or second reflector 60 may be marginally out of alignment. However, because the light source (filament 50) is distal from the aperture 66, the majority of the emitted light rays fall into the desired substantially parallel light path.

In accordance with the foregoing description, a reflector system 10, a lighting fixture 36, and a lamp 46 are provided, each advantageously able to gather light emitted from a filament and redirect it into a desirable, useful pattern. The present invention, as illustrated by the foregoing described embodiments and aspects, provides this feature without the need for employing conventional methods and devices such as collecting lenses.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, while the present invention provides methods and devices for emitting a focused, controlled light beam without use of conventional devices for focusing a light beam, such as collecting lenses, the use of such devices is not proscribed. For example, apertures 30, 34, 64, 66 as described above may be adapted to receive lenses thereover to further improve the focusing of the light beam as is known in the art. The apertures may similarly be adapted to receive a collimating lens of a type known in the art.

The apertures may also be adapted to receive glass pieces thereover, wherein the glass pieces do not significantly alter the transmission of light but merely prevent user access to the interior of the lamp or reflector system. One or more coatings may be provided on the glass pieces of a substance or substances which allow passage of visible light while reducing the passage of heat energy, ultraviolet energy, or the like. Such coatings are also known in the art. Similarly, coatings may be provided which alter the color of the transmitted light.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A dual reflector system for reflecting light produced by a lamp, comprising:
a first reflector defining a first depth and a first focal point; and
a second reflector defining a second depth and a second focal point;
wherein the second depth is less than the first depth and further wherein the first reflector focal point is substantially the same as the second reflector focal point.

2. The reflector system of claim 1, wherein the first reflector includes at least one aperture whereby a lamp having a filament for producing light may be positioned in an interior of the first reflector; and
the second reflector includes an aperture through which light energy produced by the lamp exits.

3. The reflector system of claim 1, wherein the first reflector includes at least one first aperture whereby a lamp having a filament for producing light may be positioned in an interior of the first reflector; and
further wherein the first reflector includes a second aperture through which light energy produced by the lamp exits.

4. The reflector system of claim 2, wherein the at least one first reflector aperture and the second reflector aperture are positioned in substantial alignment with a central longitudinal axis defined by the first reflector and the second reflector.

5. The reflector system of claim 3, wherein the second aperture is positioned in substantial alignment with a central longitudinal axis defined by the first reflector and the second reflector.

6. The reflector system of claim 1, wherein the first reflector focal point and the second reflector focal point are substantially on a central longitudinal axis defined by the first reflector and the second reflector.

7. A lighting fixture for producing light from an electric current supplied from an external source and directing the light, comprising:
a lamp having an envelope, a filament disposed within the envelope for producing the light, at least two filament supports, and a base supporting the envelope and the filament supports, the base having at least two contacts for supplying the electric current from the external source to the filament;
a reflector system, wherein the reflector system comprises a first reflector defining a first depth and a first focal point and a second reflector defining a second depth and a second focal point, and further wherein the second depth is less than the first depth and the first reflector focal point is substantially the same as the second reflector focal point; and
a housing for supporting the lamp and the reflector system.

8. The lighting fixture of claim 7, wherein the lamp is positioned whereby the filament is held substantially at the first reflector focal point and the second reflector focal point.

9. The lighting fixture of claim 7, wherein the first reflector includes at least one aperture through which the lamp is held in an interior of the first reflector; and
the second reflector includes an aperture through which light energy produced by the lamp exits.

10. The lighting fixture of claim 7, wherein the first reflector includes at least one first aperture through which the lamp is held in an interior of the first reflector; and
further wherein the first reflector includes a second aperture through which light energy produced by the lamp exits.

11. The lighting fixture of claim 9, wherein the at least one first reflector aperture and the second reflector aperture are positioned in substantial alignment with a central longitudinal axis defined by the first reflector and the second reflector.

12. The lighting fixture of claim 10, wherein the second aperture is positioned in substantial alignment with a central longitudinal axis defined by the first reflector and the second reflector.

13. A method for providing a high intensity beam of light, comprising the steps of:
providing a lamp having an envelope, a filament disposed within the envelope for producing the light, at least two filament supports, and a base supporting the envelope and the filament supports, the base having at least two contacts for supplying the electric current from the external source to the filament;
providing a reflector system, wherein the reflector system comprises a first reflector defining a first depth and a first focal point and a second reflector defining a second depth and a second focal point, and further wherein the second depth is less than the first depth and the first reflector focal point is substantially the same as the second reflector focal point;
positioning the lamp such that the filament is held substantially at the first reflector focal point and the second reflector focal point;
providing an electric current to the filament from the external source; and
radiating light from the filament.

14. The method of claim 13, wherein the first reflector includes at least one aperture through which the lamp is held in an interior of the first reflector; and
the second reflector includes an aperture through which light energy produced by the lamp exits.

15. The method of claim 13, wherein the first reflector includes at least one first aperture through which the lamp is held in an interior of the first reflector; and
further wherein the first reflector includes a second aperture through which light energy produced by the lamp exits.

16. The method of claim 14, wherein the at least one first reflector aperture and the second reflector aperture are positioned in substantial alignment with a central longitudinal axis defined by the first reflector and the second reflector.

17. The method of claim 15, wherein the second aperture is positioned in substantial alignment with a central longitudinal axis defined by the first reflector and the second reflector.

18. A lamp for producing light from an electric current supplied from an external source, comprising:
an envelope comprising a first reflector defining a first depth and a first focal point and a second reflector defining a second depth and a second focal point, wherein the second depth is less than the first depth and further wherein the first reflector focal point is substantially the same as the second reflector focal point;
a filament for producing the light, said filament disposed in an interior of the envelope, the first reflector, and the second reflector;
at least two filament supports; and
a base supporting the envelope and the filament supports, the base having at least two contacts for supplying the electric current from the external source to the filament;
wherein the filament is positioned substantially at the first reflector focal point and the second reflector focal point.

19. The lamp of claim 18, wherein the first reflector includes an aperture through which light energy produced by the filament exits.

20. The lamp of claim 18, wherein the second reflector includes an aperture through which light energy produced by the filament exits.

21. The lamp of claim 19, wherein the first reflector aperture is positioned in substantial alignment with a central longitudinal axis defined by the first reflector and the second reflector.

22. The lamp of claim 20, wherein the second reflector aperture is positioned in substantial alignment with a central longitudinal axis defined by the first reflector and the second reflector.

23. The lamp of claim 18, wherein the first reflector focal point and the second reflector focal point are substantially on a central longitudinal axis defined by the first reflector and the second reflector.
